(19) United States
(12) Patent Application Publication
(10) Pub. No.: US 2022/0414016 A1
(43) Pub. Date: Dec. 29, 2022

(54) CONCURRENT PROCESSING OF MEMORY MAPPING INVALIDATION REQUESTS

(71) Applicants: ADVANCED MICRO DEVICES, INC., Santa Clara, CA (US); ATI TECHNOLOGIES ULC, Markham (CA)

(72) Inventors: Wade K. Smith, Santa Clara, CA (US); Anthony Asaro, Markham (CA)

(21) Appl. No.: 17/355,820

(22) Filed: Jun. 23, 2021

(51) Int. Cl. G06F 12/0891

(52) U.S. Cl. CPC G06F 12/0891; G06F 2212/68

(57) ABSTRACT

A translation lookaside buffer (TLB) receives mapping invalidation requests from one or more sources, such as one or more processing units of a processing system. The TLB includes one or more invalidation processing pipelines, wherein each processing pipeline includes multiple processing states arranged in a pipeline, so that a given stage executes its processing operations concurrent with other stages of the pipeline executing their processing operations.

### BACKGROUND

A processing system typically provides a set of memory resources, such as one or more caches, one or more memory modules that form the system memory for the processing system, and the like. The memory resources include a set of physical memory locations to store data, wherein each memory location is associated with a unique physical address that allows the memory location to be identified and accessed. To provide for efficient and flexible use of memory resources, many processing units support virtual addressing, wherein an operating system maintains virtual address spaces for one or more executing programs, and the processing unit provides hardware structures that support translation of virtual addresses to corresponding physical addresses of the memory resources.

For example, a processing unit typically includes one or more translation lookaside buffers (TLBs) that stores, in one or more caches, virtual-to-physical address mappings for recently accessed memory locations. As the operating system or other system resource changes the virtual memory space, the mappings stored in the one or more caches become outdated. Accordingly, to maintain memory coherency and proper program execution, a processing system can support mapping invalidation requests, wherein the operating system or other resource requests that specified virtual-to-physical address mappings at the cache be declared invalid, so that such mappings are not used for address translation. However, conventional techniques for executing such mapping invalidation requests have relatively low throughput, limiting overall efficiency and flexibility of the processing system.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that implements concurrent processing of mapping invalidation requests in accordance with some embodiments.

FIG. 2 is a block diagram of a set of invalidation pipelines of the processing system of FIG. 1 in accordance with some embodiments.

FIGS. 3-5 are block diagrams illustrating an example of the invalidation pipelines of FIG. 2 concurrently processing different mapping invalidation requests in accordance with some embodiments.

FIG. 6 is a block diagram illustrating an example of the processing system of FIG. 1 suppressing a page walk request in response to a mapping invalidation request in accordance with some embodiments.

### DETAILED DESCRIPTION

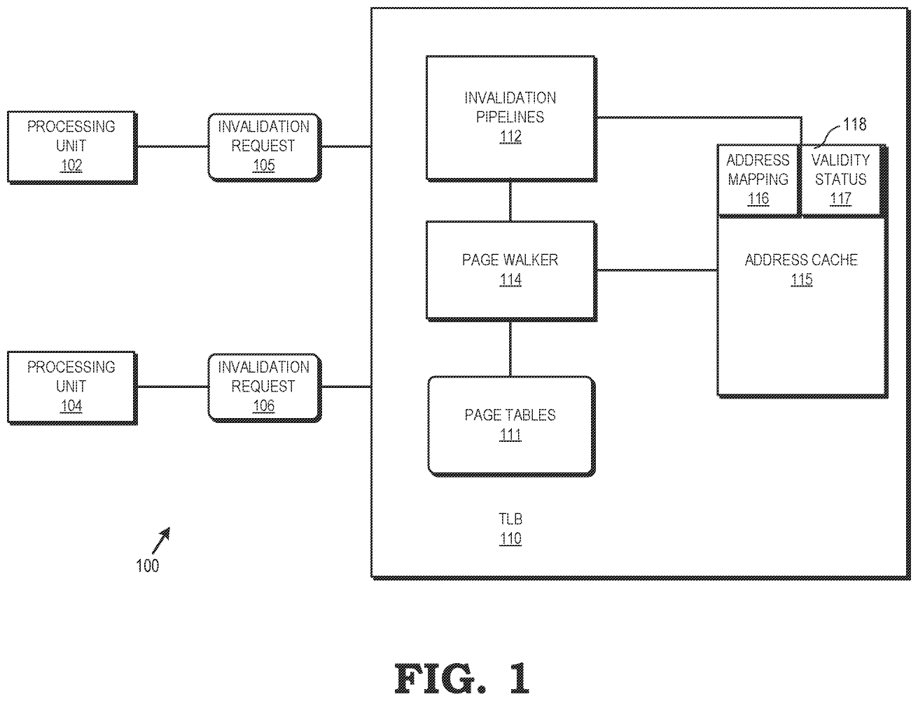

FIGS. 1-6 illustrate techniques for concurrently processing mapping invalidation requests at a processing system. In some embodiments, a TLB receives the mapping invalidation requests (referred to herein for simplicity as invalidation requests) from one or more sources, such as one or more processing units of the processing system. The TLB includes one or more invalidation processing pipelines, wherein each processing pipeline includes multiple processing states arranged in a pipeline, so that a given stage executes its processing operations concurrent with other stages of the pipeline executing their processing operations. Thus, in some cases the TLB submits multiple received invalidation requests to the one or more pipelines, where the multiple invalidation requests are processed concurrently. By processing the invalidation requests in this pipelined fashion, the TLB improves overall invalidation request throughput, thereby improving overall processing efficiency.

To illustrate, some processing systems update the system virtual address space relatively frequently. For example, some processing systems frequently switch between executing programs, necessitating frequent corresponding changes in the virtual address space. To effect these changes, an operating system executing at the processing system generates different invalidation requests, with each invalidation request designating a set of TLB cache entries to be invalidated, thus ensuring that these entries are not used for address translation. Conventionally, each invalidation request is processed in turn, with one request completing before another request begins processing. While this approach supports safe memory management, the resulting low throughput for invalidation requests negatively impacts overall system efficiency. By concurrently processing multiple invalidation requests using the techniques described herein, invalidation request processing throughput is increased, and overall processing efficiency is thereby improved.

In some embodiments, the TLB generates the address mappings for the cache by traversing sets of page tables that store the address mappings for a given program, program thread, and the like. The traversal process that generates the address mappings are referred to herein as a “page walk.” In some cases, the TLB receives invalidation requests for memory addresses that are associated with a pending page walk. That is, in some cases, the TLB is in the process of executing a page walk for a given memory address concurrent with receiving an invalidation request targeting the given memory address. To prevent the page walk from polluting the cache with an incorrect address mapping, the TLB suppresses updates of the memory mappings from page walks for memory addresses that are the target of a received invalidation request. For example, in some embodiments, the TLB designates the results of a such a page walk with an identifier that prevents the results of the page walk from being stored at the cache.

FIG. 1 illustrates a processing system 100 that concurrently processes mapping invalidation requests in accordance with some embodiments. The processing system 100 is generally configured to execute sets of instructions (e.g., computer programs, operating systems, applications, and the like) on behalf of an electronic device. Accordingly, in different embodiments, the processing system 100 is incorporated into any of a number of electronic devices, such as a desktop computer, laptop computer, server, smartphone, tablet, game console, and the like. To support execution of the sets of instructions, the processing system 100 includes processing units 102 and 104 and a translation lookaside buffer (TLB) 110. In some embodiments, the processing system 100 includes additional modules and circuits not illustrated at FIG. 1, including additional processing units, memory modules such as one or more caches and memory modules that form the system memory for the processing system 100), one or more memory controllers, one or more input/output controllers and devices, and the like.

The processing units 102 and 104 are units that are generally configured to execute sets of instructions to perform one or more tasks defined by the instructions. For example, in some embodiments, at least one of the processing units 102 and 104 is a central processing unit (CPU) that is configured to execute the sets of instructions that form programs, operating systems, and the like As another example, in some embodiments at least one of the processing units 102 and 104 is a graphics processing unit (GPU) that executes sets of instructions (e.g., wavefronts or warps) based on commands received from another processing unit, such as a CPU.

As noted above, in some embodiments the processing system 100 includes one or more data caches and one or more memory modules that form system memory. Collectively, the one or more caches and the system memory are referred to herein as the memory hierarchy of the processing system 100. In the course of executing instructions, the processing units 102 and 104 generate operations, referred to as memory access requests, to store data at and retrieve data from the memory hierarchy. Each memory access request includes an address designating the memory location where the corresponding data is stored at the memory hierarchy. To simplify memory access for the executing instructions, an operating system of the processing system 100 maintains virtual address spaces for the executing programs, applications, and the like. Each virtual address space defines a relationship, or mapping, between a set of virtual addresses and a set of physical addresses, where each physical address is uniquely associated with a different memory location of the memory hierarchy of the processing system 100. As data is moved around the memory hierarchy by the processing system 100, the operating system or memory hardware of the processing system 100, or a combination thereof, update the virtual address space to maintain the correct mappings that ensure proper execution of the programs and applications.

To support the virtual address spaces, the processing system includes the TLB 110, which is generally configured to translate virtual addresses to physical addresses. For example, the processing units 102 and 104 provide the TLB 110 with the virtual addresses associated with generated memory access requests. In response, the TLB 110 translates each received virtual address to the corresponding physical address. A memory controller or other module (not shown) of the processing system 100 employs the physical address to access the location of the memory hierarchy indicated by the physical address, and to thereby execute the memory access request.

To perform address translation, the TLB 110 includes an address cache 115 and a page walker 114. The address cache 115 is a memory generally configured to store recently-used address mappings. In particular, the address cache 115 includes a plurality of entries (e.g., entry 118), wherein each entry includes a mapping field (e.g., mapping field 116) that stores a virtual-to-physical address mapping) and a validity status field (e.g., validity status field 117) that stores status information indicating whether the corresponding mapping field stores a valid mapping that is to be used for address translation. It will be appreciated that in other embodiments, the validity status information is not stored at the address cache 115 itself, but is instead stored at another portion of the TLB 110, such as a table of status information for the address cache 115.

The page walker 114 is a set of hardware configured to execute page walk operations on a set of page tables 111 maintained by the operating system, where in the page tables store the virtual-to-physical address mappings for the sets of instructions executing at the processing units 102 and 104. In response to receiving an address translation request for a virtual address from a processing unit, the TLB 110 determines whether a mapping for the virtual address is stored at an entry of the address cache 115. If so, the TLB 110 uses the mapping stored at the address cache 115 to translate the virtual address to the corresponding physical address and provides the physical address to the processing unit that requested the translation.

If the mapping for the virtual address is not stored at the address cache 115, the TLB 110 instructs the page walker 114 to perform a page walk of the page tables 111 using the virtual address. The page walker 114 executes the page walk to retrieve the virtual-to-physical address mapping corresponding to the virtual address from the page tables 111. The TLB 110 stores the retrieved address mapping at a mapping field of an entry of the address cache 115, sets the validity status for the entry to the valid status (indicating that the stored mapping is to be used for address translation) and provides the physical address to the processing unit that requested the translation.

In some cases, an operating system or other program executing at one or more of the processing units 102 and 104 changes the virtual address space for the processing system 100. For example, in some cases the operating system maintains different virtual address spaces for different programs, and changes the virtual address space in response to changing which program is executing at one or more of the processing units 102 and 104. However, when the virtual address space is changed, the address cache 115 sometimes stores address mappings that are no longer valid for the current virtual address space. Accordingly, in response to changing the virtual address space, the operating system or other program sends one or more invalidation requests (e.g., invalidation requests 105 and 106) to the TLB 110. Each invalidation request indicates a virtual memory address, or set of virtual memory addresses, that have mappings that are not valid for the current virtual address space. In response to receiving an invalidation request, the TLB 110 identifies one or more entries of the cache 115 that store mappings for the set of virtual addresses indicated by the invalidation request and sets the validity status fields for those entries to indicate that those entries store invalid data. Thus, in response to receiving an invalidation request, the TLB indicates that one or more entries of the cache 115, as identified by the request, are invalid so that the address mappings stored at those entries are not used for address translation.

In some embodiments, the TLB implements multiple processing operations to satisfy each invalidation request, such as operations to identify the address or address range identified by the request, operations to provide notifications of the invalidation to different portions of the processing system 100 (e.g., to maintain memory coherency), operations to ensure that the results of any page walks targeting addresses corresponding to the invalidation request, operations to identify the entry or entries of the cache 115 that are to be invalidated, operations to set status information for the identified entry to indicate the invalid status, and any other operations to execute the invalidation request. Further, in some cases these different operations together require multiple processing cycles (e.g., multiple cycles of a clock signal that governs the operations of the TLB 110). Accordingly, in some cases the TLB 110 receives an invalidation request while another invalidation request is being processed. For example, in some cases the TLB 110 receives the invalidation request 106 while the invalidation request 105 is being processed, or as the invalidation request is ready for processing. Accordingly, and to improve invalidation request throughput, the TLB 110 is generally configured to concurrently process different invalidation requests, such as the invalidation request 105 and 106.

To support concurrent processing of invalidation requests, the TLB 110 includes invalidation pipelines 112. As described further herein, each of the invalidation pipelines 112 includes multiple stages, wherein each stage of an invalidation pipeline includes circuitry to carry out a specified processing operation for executing an invalidation request, such as operations to identify the address or address range identified by the request, operations to provide notifications of the invalidation to different portions of the processing system 100 (e.g., to maintain memory coherency), operations to ensure that the results of any page walks targeting addresses corresponding to the invalidation request, operations to identify the entry or entries of the cache 115 that are to be invalidated, operations to set status information for the identified entry to indicate the invalid status, and any other operations to execute the invalidation request. Each pipeline stage is configured to operate independently of the other pipeline stages, so that different stages of the pipeline concurrently execute operations for different invalidation requests. That is, a given stage of an invalidation pipeline executes a processing operation for one invalidation request (e.g., invalidation request 105) concurrent with another stage of the pipeline executing a different operation for a different invalidation request (e.g., invalidation request 106). By pipelining invalidation operations in this way, the TLB 110 concurrently satisfies multiple invalidation requests, thus increasing invalidation request throughput and improving overall efficiency of the processing system 100.

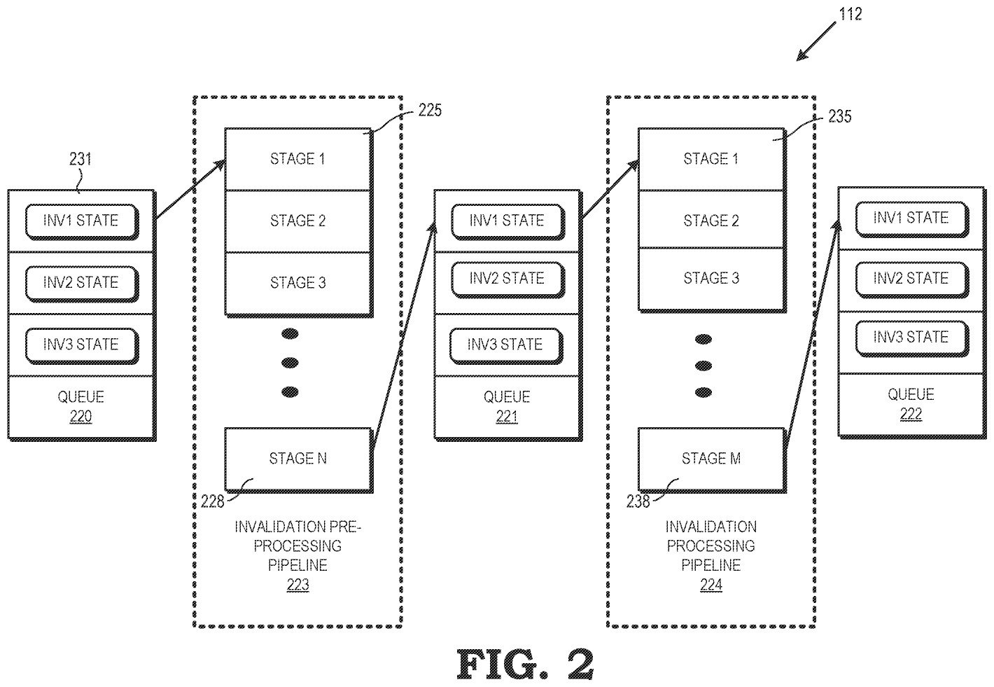

A block diagram of an example of the invalidation pipelines 112 is illustrated at FIG. 2 in accordance with some embodiments. In the depicted example, the invalidation pipelines 112 include an invalidation preprocessing pipeline 223 and an invalidation processing pipeline 224. The invalidation preprocessing pipeline 223 is generally configured to execute processing operations associated with preparing an invalidation request for invalidation execution—that is, processing operations that prepare the TLB 110 to invalidate the one or more entries of the cache 115 targeted by the invalidation request. Examples of operations implemented by the invalidation preprocessing pipeline 223 include operations to communicate with other modules of the processing system 100 to determine if executing the invalidation request is likely to cause errors (e.g., because the other modules expect to employ the address mappings targeted by the invalidation request), operations to identify any page walk operations associated with entries targeted by the invalidation request, operations to identify the entries of the cache 115 targeted by the request, and the like.

In some embodiments, other examples of operations implemented by stages of the invalidation preprocessing pipeline 223 include tracking completion of the invalidation request with respect to any ongoing page walks targeted to the same memory address, and notifying other caches of the invalidation request and tracking the notifications to confirm that the requisite caches have been notified and that it is safe to proceed to the invalidation pipeline 224. In some embodiments, the invalidation preprocessing pipeline 223 implements operations to identify characteristics of the invalidation request that are used by the invalidation processing pipeline 224 to control which memory address mappings are invalidated, such as one or more of an address range associated with the invalidation request, a virtual memory identifier associated with the request, a virtual machine identifier associated with the request, and the like.

The invalidation processing pipeline 224 is generally configured to execute processing operations associated with performing the requested invalidations indicated by the invalidation request. In other words, the invalidation processing pipeline 224 implements processing operations that cause the one or more entries of the cache 115 targeted by the invalidation request to be set to the invalid status. Examples of operations implemented by the invalidation processing pipeline 223 include operations to access entries of the cache 115 targeted by the invalidation request, operations to change status information for the accessed entries to indicate the invalid status, operations to notify other caches or memory modules of the invalid status of the entries, and the like.

Each of the pipelines 223 and 224 includes multiple stages, wherein each pipeline stage is configured to execute one or more of the processing operations for the respective pipeline. In particular, the invalidation preprocessing pipeline 223 includes an initial stage 225 and additional stages through an Nth stage 228, where N is an integer. Similarly, the invalidation processing pipeline 224 includes an initial stage 235 and additional stages through a Mth stage 238, where M is an integer. In some embodiments, the pipelines 223 and 224 include the same number of stages (i.e., N=M) while in other embodiments the pipelines 223 and 224 include a different number of stages (i.e. N and M are different).

To support processing of invalidation requests at the pipelines 223 and 224, the invalidation pipelines 112 include queues 220, 221, and 222, wherein each of the queues 220-222 includes a plurality of entries (e.g., entry 231 of queue 220) and each entry is configured to store state information for a corresponding invalidation request. As an invalidation request is processed, the stages of the pipelines 223 and 224 use the state information for an invalidation request as input information, change the state information for the invalidation request based on the processing operations associated with the stage, and the like, or any combination thereof.

In operation, the entries of the queue 220 store state information for received invalidation requests. To process an invalidation request the initial stage 225 of the invalidation preprocessing stage uses the state information for the invalidation request, as stored at a corresponding entry of the queue 220, to perform one or more preprocessing operations. In the course of performing the one or more operations, the stage 225 changes the stored state information based on the operations being performed. Upon completion of the one or more operations, the invalidation request is passed to the next stage of the invalidation preprocessing pipeline 223 (designated “Stage 2” at FIG. 2), which executes one or more corresponding preprocessing operations, using the state information for the invalidation request as stored at the corresponding entry of the queue 220. In similar fashion, the invalidation request proceeds through the invalidation preprocessing pipeline 223, each stage executing the corresponding preprocessing operations, until reaching the final stage 228. Upon completing the preprocessing operations for the invalidation request, the stage 228 stores the resulting state information for the invalidation request at an entry of the queue 221.

The invalidation processing pipeline 224 processes invalidation requests in a pipelined fashion similar to that described above with respect to the invalidation preprocessing pipeline 223, using and modifying the state information stored at entries of the queue 221. Beginning at the initial stage 235, the invalidation request proceeds through the stages of the invalidation processing pipeline 224, each stage executing the corresponding preprocessing operations, until reaching the final stage 238. Upon completing the preprocessing operations for the invalidation request, the stage 238 stores the resulting state information for the invalidation request at an entry of the queue 222. In some embodiments, the state information at the queue 222 is used by the TLB 110 or other modules of the processing system 100 to perform additional operations.

Each of the stages of the pipelines 223 and 224 are configured to operate independently, such that one stage of a pipeline performs the corresponding operations for a given invalidation request, while a different stage of the pipeline is concurrently performing the corresponding operations for a different invalidation request. For example, in some embodiments, each stage of the pipelines 223 and 224 is configured to execute its corresponding operations in a specified amount of time, referred to as a processing cycle. In some embodiments, each processing cycle is equivalent to a single clock cycle of a clock signal that governs the operations of the TLB 110. That is, in some embodiments, each stage of the pipelines 223 and 224 completes its corresponding operations in a single clock cycle, and then passes the respective invalidation request to the next stage of the respective pipeline.

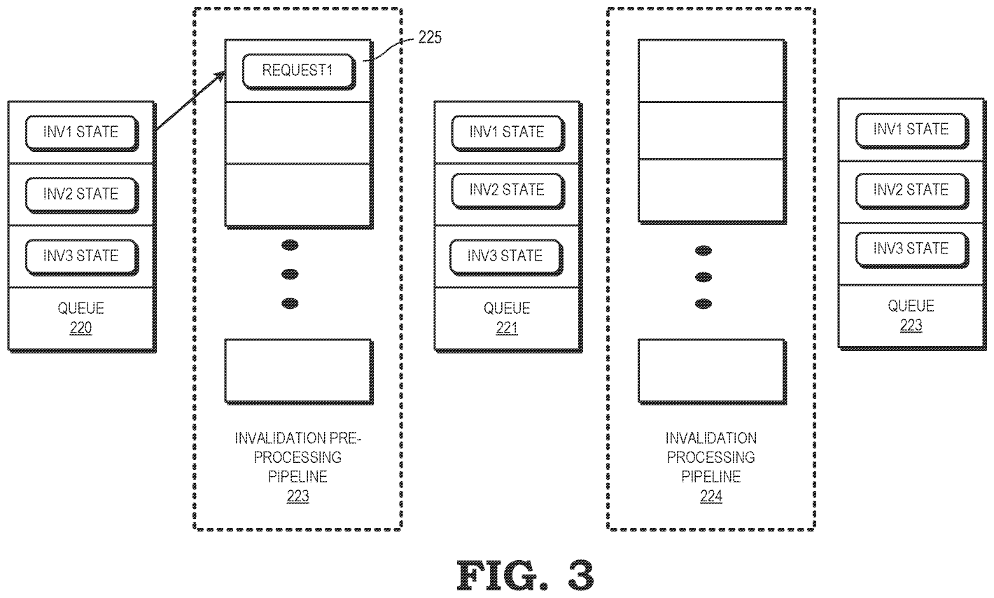

An example of the pipelining of concurrent processing for multiple invalidation requests is illustrated at FIGS. 3-5 in accordance with some embodiments. For simplicity, FIGS. 3-5 illustrate pipelining of multiple invalidation requests at the invalidation preprocessing pipeline 223. However, it will be appreciated that the invalidation processing pipeline 224 pipelines operations in similar fashion. Each of the FIGS. 3-5 illustrate a different processing cycle for the invalidation processing pipeline 223.

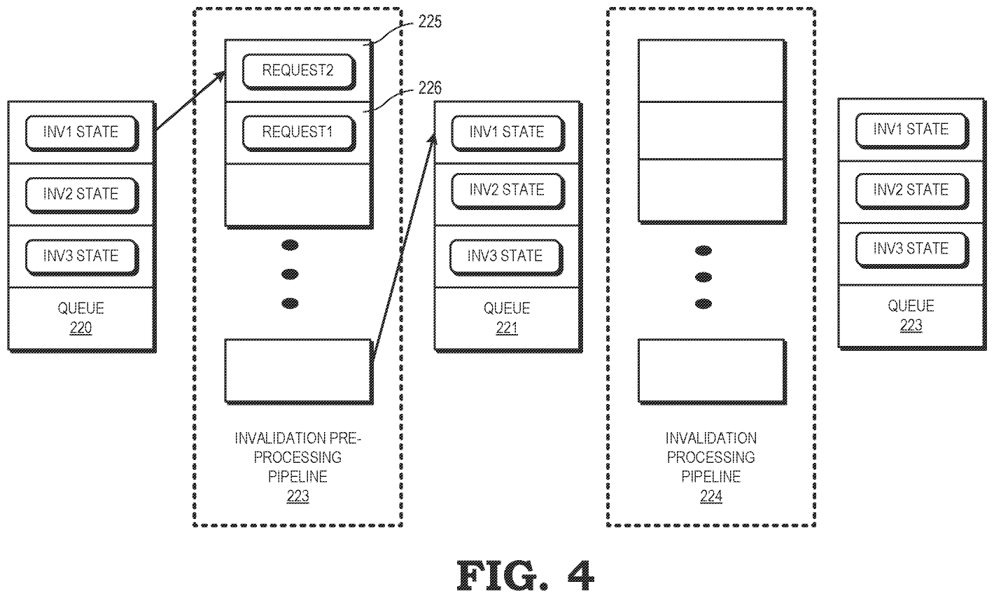

In particular, FIG. 3 illustrates an initial processing cycle, wherein three invalidation requests (designated for purposes of the example as Request1, Request2, and Request3) are available for concurrent processing at the invalidation preprocessing pipeline 223. Each of Request1, Request2, and Request3 is associated with corresponding state information, designated INV1 STATE, INV2 STATE, AND INV3 STATE, respectively, at the queue 220. For the initial processing cycle illustrated at FIG. 3, Request1 is processed at the initial stage 225 of the invalidation pre-processing pipeline 223. The stage 225 completes its operations for Request1 during this initial cycle, and passes Request1 to the next stage, illustrated at FIG. 4.

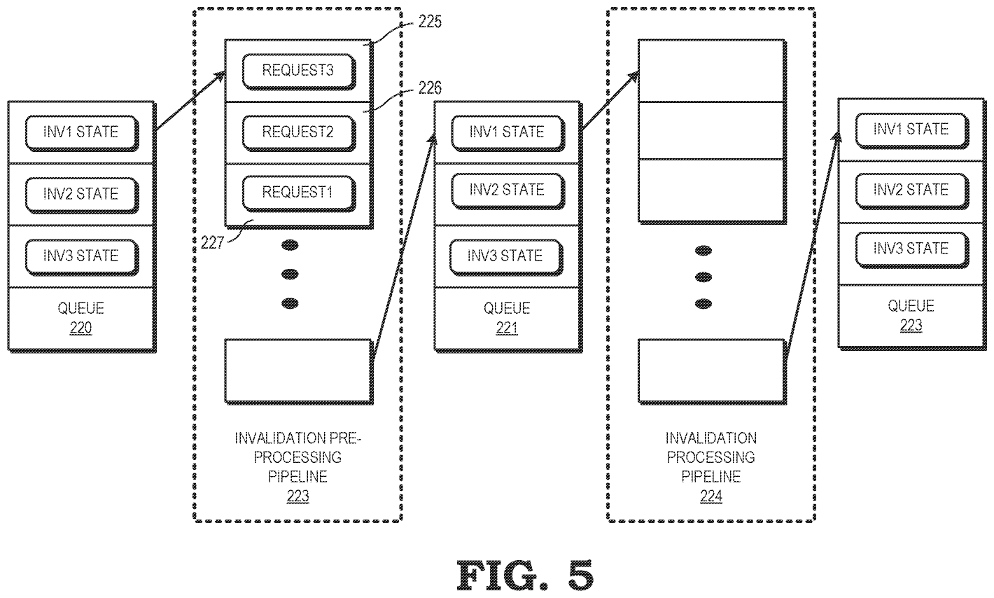

As illustrated at FIG. 4, during the next processing cycle (that is, the processing cycle immediately following the initial cycle illustrated at FIG. 3), Request1 is processed at a second stage 226, wherein the second stage 226 immediately follows the initial stage 225 at the invalidation preprocessing pipeline 223. In addition, Request2 is processed at the initial stage 225. Thus, during the processing cycle illustrated at FIG. 4, Request1 and Request2 are concurrently processed at different stages of the invalidation preprocessing pipeline 223. By the end of the processing cycle, each of the stages 225 and 226 passes the respective invalidation request to the next stage of the pipeline 223 for further processing during the next processing cycle, illustrated at FIG. 5.

As depicted at FIG. 5, during the next processing cycle (that is, the processing cycle immediately following the processing cycle illustrated at FIG. 4), Request1 is processed at a third stage 227, wherein the third stage 227 immediately follows the initial stage 226 at the invalidation preprocessing pipeline 223. In addition, Request2 is processed at the second stage 226, and Request3 is processed at the initial stage 225. Thus, during the processing cycle illustrated at FIG. 5, Request1, Request2, and Request3 are all concurrently processed at different stages of the invalidation preprocessing pipeline 223. Thus, in the example presented at FIGS. 3-5, multiple invalidation requests are concurrently processed at different stages of an invalidation pipeline. In contrast, a conventional TLB completes processing of each invalidation request before initiating processing of the next received invalidation request, limiting overall invalidation request throughput.

In some embodiments, the TLB generates the address mappings for the cache by traversing sets of page tables that store the address mappings for a given program, program thread, and the like. The traversal process that generates the address mappings are referred to herein as a “page walk.” In some cases, the TLB receives invalidation requests for memory addresses that are associated with a pending page walk. That is, in some cases, the TLB is in the process of executing a page walk for a given memory address concurrent with receiving an invalidation request targeting the given memory address. To prevent the page walk from polluting the cache with an incorrect address mapping, the TLB suppresses updating of memory mappings based on page walks for memory addresses that are the target of a received invalidation request. For example, in some embodiments, the TLB designates the results of a such a page walk with an identifier that prevents the results of the page walk from being stored at the cache.

Returning to FIG. 1, as noted above the page walker 114 is generally configured to execute page walks by traversing the page tables 111, thereby generating address mappings for storage at the address cache 115. However, in some embodiments, the TLB 110 receives invalidation requests for memory addresses that are associated with a pending page walk. In other words, in some cases the page walker 114 is in the process of executing a page walk for a given memory address, or range of memory addresses, concurrent with receiving an invalidation request targeting the given memory address, or an address in the memory address range. This sometimes creates a race condition, wherein the results of the page walk are generated after the invalidation process would otherwise complete, causing an invalid mapping to be stored at the address cache 115 and potentially resulting in program execution errors.

In some embodiments, to address this race condition, the invalidation pipelines 112 are configured to notify the page walker 114 of the memory addresses, or memory address ranges, targeted by each memory access request. The page walker 114 identifies any pending page walks corresponding to those memory addresses and suppresses the results of the identified page walks from being stored at the address cache 115. In some embodiments, the page walker 114 suppresses the results by allowing the corresponding page walk to complete, but sets a status identifier to indicate that the address mapping resulting from the page walk are invalid. Before storing any address mapping, the address cache 115 checks the corresponding status identifier and, if the status identifier indicates the address mapping is invalid, discards (that is, does not store) the address mapping.

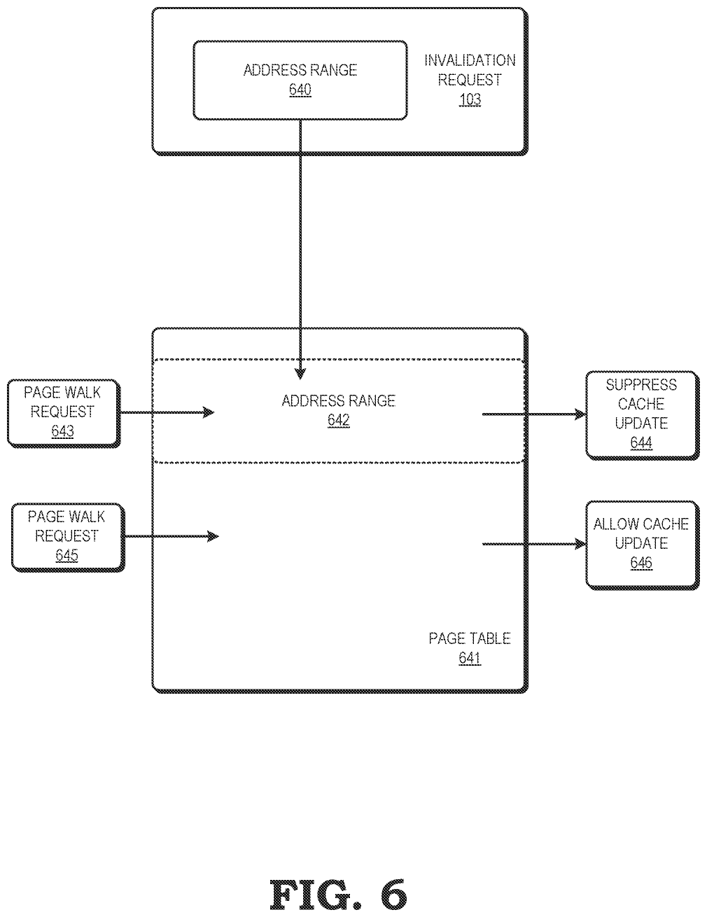

An example of suppressing the results of a page walk in response to receiving an invalidation request is illustrated at FIG. 6 in accordance with some embodiments. In the depicted example, the invalidation request 103 includes an address range 640 indicating a range of memory addresses with address mappings that are to be invalidated at the address cache 115. In response to receiving the invalidation request 103, the invalidation pipelines 112 invalidate each entry of the address cache 115 that are associated with memory addresses in the address range 640. In addition, the invalidation pipelines 112 indicate the address range 640 to the page walker 114.

In response to receiving the address range 640, the page walker 114 identifies a portion of a page table 641, illustrated as address range 642, that corresponds to the address range 640. That is, the address range 642 represents the portion of the page table 641 that includes address mappings for the address range 640. It will be appreciated that, in some embodiments, the address range 642 corresponds to different portions of multiple page tables. In addition, while address range 642 is illustrated as a contiguous region of the page table 641, in some embodiments the address range 642 includes non-contiguous portions of the page table 641, or non-contiguous portions of multiple page tables.

In response to identifying the address range 640, the page walker 114 identifies any page walk requests that target a memory address in the address range 642. In the depicted example, a page walk request 643 targets a memory address in the address range 642, while a different page walk request 645 targets a memory address outside the address range 642. Accordingly, as illustrated by block 644, the page walker 114 suppresses the results of the page walk request 643, so that the results for the page walk request 643 are not stored at the address cache 115. Further, as illustrated by block 646, the page walker 114 allows the results of the page walk request 645 to be stored at the address cache 115.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving a plurality of invalidation requests at a translation lookaside buffer (TLB), each of the plurality of invalidation requests associated with a corresponding one of a plurality of memory addresses; and
concurrently processing the plurality of invalidation requests at the TLB to invalidate data associated with each of the plurality of memory addresses.

2. The method of claim 1, wherein concurrently processing the plurality of invalidation requests comprises:
assigning each of the plurality of invalidation requests to a corresponding entry of a first queue, each entry of the first queue storing state information indicating a state of the corresponding invalidation request.

3. The method of claim 2, wherein concurrently processing the plurality of invalidation requests comprises:
processing a first entry of the first queue at a first invalidation processing pipeline stage associated with a first invalidation operation.

4. The method of claim 3, concurrently processing the plurality of invalidation requests comprises:
processing a second entry of the first queue at a second invalidation processing pipeline stage associated with a second invalidation operation.

5. The method of claim 4, wherein processing the plurality of invalidation requests comprises:
processing the first entry at the first invalidation processing pipeline stage concurrent with processing the second entry of the first queue at the second invalidation pipeline stage.

6. The method of claim 1, further comprising:
in response to receiving a first invalidation request of the plurality of invalidation requests:
identifying a first address range associated with the first invalidation request of the plurality of invalidation requests; and
suppressing a first page walk operation associated with first address range.

7. The method of claim 6, wherein suppressing the first page walk operation comprises restarting the first page walk operation concurrent with processing the first invalidation request.

8. A method, comprising:
in response to receiving a first invalidation request at a memory controller, the first invalidation request to invalidate data associated with a first memory address:
identifying a first address range associated with the first invalidation request of a plurality of invalidation requests; and
suppressing a first page walk operation associated with first address range.

9. The method of claim 8, further comprising:
concurrent with suppressing the first page walk operation, processing the first invalidation request to invalidate the data associated with the first memory address.

10. The method of claim 9, further comprising:
concurrent with processing the first invalidation request, processing a second invalidation request to invalidate data associated with a second memory address.

11. The method of claim 10, wherein processing the first invalidation request comprises processing the first invalidation request at a first stage of an invalidation processing pipeline concurrent with processing the second invalidation request at a second stage of the invalidation pipeline.

12. The method of claim 11, wherein processing the first invalidation request at the first stage of the invalidation processing pipeline comprises transferring first state information associated with the first invalidation request from a first queue to a second queue via first processing logic associated with a first invalidation operation.

13. The method of claim 12, wherein processing the second invalidation request at the second stage of the invalidation processing pipeline comprises transferring second state information associated with the second invalidation request from the second queue to a third queue via second processing logic associated with a second invalidation operation.

14. The method of claim 8, further comprising:
in response to receiving a second invalidation request, the second invalidation request to invalidate data associated with a second memory address:
identifying a second address range associated with the second invalidation request of the plurality of invalidation requests; and
suppressing a second page walk operation associated with second address range.

15. A processor comprising:
a translation lookaside buffer (TLB) comprising:
a cache to store a plurality of virtual-to-physical address mappings;
at least one invalidation processing pipeline to concurrently process a plurality of invalidation requests by invalidating or more of the plurality of virtual-to-physical address mappings.

16. The processor of claim 15, wherein the at least one invalidation processing pipeline comprises:
a first queue, each entry of the first queue storing state information indicating a state of the corresponding invalidation request.

17. The processor of claim 16, wherein the at least one invalidation processing pipeline comprises:
a first stage associated with a first invalidation operation, the first stage to process a first entry of the first queue.

18. The processor of claim 17, the at least one invalidation processing pipeline comprises:
a second stage associated with a second invalidation operation, the first stage to process a second entry of the first queue.

19. The processor of claim 18, wherein:
the first stage is to process the first entry of the first queue concurrent with the second stage processing the second entry of the first queue.

20. The processor of claim 15, wherein the TLB further comprises:
a page walker to, in response to receiving a first invalidation request of the plurality of invalidation requests:
identify a first address range associated with the first invalidation request; and
suppress a first page walk operation associated with first address range.
